(19) United States
(12) Patent Application Publication
(10) Pub. No.: US 2025/0317483 A1
(43) Pub. Date: Oct. 9, 2025

(54) SAFE RIDE APP

(71) Applicant: ANTHONY JOSEPH VOLO, MERIDEN, CT (US)

(72) Inventor: ANTHONY JOSEPH VOLO, MERIDEN, CT (US)

(21) Appl. No.: 18/628,782

(22) Filed: Apr. 7, 2024

(51) Int. Cl. H04L 65/613; G06V 40/16

(52) U.S. Cl. CPC H04L 65/613; G06V 40/172

(57) ABSTRACT

A system and method for enhancing safety in rideshare services through live video and audio streaming, AI-based behavioral anomaly detection, GPStracking, smart device sensor input, and real-time remote monitoring via safety codes. The system provides both internal and external live feeds from the driver's mobile device, along with alternative monitoring tools such as audio analysis, motion sensing, facial verification, panic detection, and dynamic safety scoring. The system enables trusted individuals (Guardians) to monitor rides in real-time and receive alerts upon detection of irregular or unsafe activity.

### OBJECTIVE

To enhance safety and security for passengers and drivers in rideshare services by incorporating real time live streaming and remote monitoring features.

### Key Features

1. Driver's Live Stream (Internal and External View)
The app uses the driver's smartphone to live stream:
INTERNAL VIEW: The interior of the care. showing the driver and passenger area.
EXTERNAL VIEW: The car's surroundings and license plate to verify vehicle identity.
Video feeds are securely stored on a cloud server for future references.
2. Safety Code System:
A unique ride code is generated for each trip
Passengers can share this code with a trusted person or A Guardian to enable real-time monitoring.
3. Monitoring:
Trusted individuals can enter the shared code in a separate “MONITOR PORTAL” in the app or on the web.
Trusted person gain access to:
LIVE INTERNAL VIEW: Monitor the driver and passenger.
LIVE EXTERNAL VIEW: Verify the vehicle's surroundings and route.
Trusted person receive alerts if unusual activity is detected (e.g. prolonged stops in unsafe areas)
4. Passenger Verification
Passengers can view the driver's live feed to verify:
Driver identity (Matches app profile) also face recognition etc. security features
Vehicle interior and exterior conditions
License plate for accurate ride matching
5. AI Safety Alerts.
The system uses AI to monitor the live feed and detect anomalies. such as:
Sudden stops or deviations from the route
Unusual or aggressive driver/passenger behavior
Entry into high-risk areas
Alerts are sent to the passenger. driver and trusted person or guardian when anomalies are detected. They can all alert a panic button to authorities
6. Emergency Assistance.
Both passenger or trusted person an also Driver can press a panic button in the app:
Instantly shares live location and video feed with emergency services
Alerts the rideshare company's safety team,
7. End to End Encryption
All video streams and data are encrypted to ensure privacy and security

### Workflow

1. Booking the Ride
Passenger books the ride via the app and receives the driver's details and unique safety code
2. Starting the Live Stream
Driver starts the live stream before picking up the passenger when they start the process
Passenger verifies the driver and vehicle using the live stream and security features
3. Sharing the Code
Passenger shares the safety code with their trusted person.
Trusted person enters the code into the app to start monitoring
4. Real-Time Monitoring
Trusted person and passenger monitor the ride via the app
AI provides alerts for any unusual activity
5. Emergency Handling
Panic button is used if there is a safety concern.
Live video and location are shared with emergency contacts and services also all information and sent to location when panic button is pressed live stream can be followed Also.
6. Ending the Ride.
Once the ride is completed safely, the live stream ends automatically

### Technical Components

1. Mobile App
For drivers. Passengers or trusted person guardians
Integrated camera access for live streaming
2. Cloud Infrastructure
For secure video storage and live streaming
3. AI Monitoring System
Analyzes video feeds for safety anomalies
4. Encryption Protocols
Ensures data security for all streams and communications
5. Web Interface
For guardians or trusted person who prefer to monitor via a browser
6. Gps for location; also all other features for standard ride share.

### BACKGROUND OF THE INVENTION

Traditional rideshare systems offer limited safety verification once a ride has commenced. There exists a need for a real-time monitoring and safety system that can stream live footage securely, detect anomalies or threats, provide evidence storage, empower third parties to remotely monitor or intervene, and operate effectively with or without live video.

### SUMMARY OF THE INVENTION

The present invention provides a comprehensive safety platform for passengers and drivers in rideshare services, combining live streaming, AI-driven anomaly detection, motion sensors, smart alerts, and a Guardian monitoring system. The system uses the driver's smartphone cameras and sensors, offers secure cloud storage for evidence, enables ride verification through facial recognition, alerts guardians or authorities in real-time during high-risk events, and works even without continuous video feed through sensor and audio-based tools.

### DETAILED DESCRIPTION OF THE INVENTION

### A. Live Video Streaming

Internal Camera Feed: Captures the vehicle cabin including driver and passenger areas.
External Camera Feed: Captures surroundings and license plate.
Cloud Storage: All video is encrypted and uploaded to a remote server for future reference.
Driver Verification: Periodic facial recognition checks ensure only registered drivers operate the vehicle.

### B. Safety Code System

A unique Ride Code is generated for every trip.
Code is sharable with a trusted individual (“Guardian”).
The Guardian uses this code to access a live monitoring portal (web or app).

### C. Guardian Monitoring Portal

Allows real-time access to:
   Internal video stream
   External video stream
   Real-time GPS location
   Safety score and ride behavior summary
Guardian receives push alerts for:
   Prolonged stops in unsafe areas
   Audio anomalies (yelling, distress keywords)
   Deviations from expected route

### D. AI-Powered Anomaly Detection

Live feed and sensor data are analyzed for:
   Route deviations
   Dangerous driving or erratic behavior
   Entry into high-crime zones (API integration)
   Unusual audio patterns (e.g., screaming, fighting)
   Motion patterns from phone sensors (e.g., rapid swerving, impact)
Each ride is assigned a dynamic safety score.

### E. Audio-Only Mode (No Video)

Automatically activated in low-bandwidth or privacy-restricted zones.
Encrypted audio is recorded and AI-analyzed.
Triggers alerts upon distress indicators or unusual silence.
Can be toggled by user settings or based on passenger preference.

### F. Device Motion and Sensor Detection

Uses phone's:
   Accelerometer
   Gyroscope
   Magnetometer
Detects:
   Hard braking
   Collisions
   Sudden turns
   Phone toss/drop patterns (e.g., potential struggle)
Behavior logged and used to score ride safety.

### G. Panic Button Mechanisms

Available to both driver and passenger.
Can be activated:
   Visibly via button
   Silently via voice trigger (“Help me!”)
   By motion gesture or pattern (e.g., 3 taps)
Triggers:
   Live stream link sent to emergency contacts
   Immediate GPS ping to authorities
   Snapshot of vehicle's interior and surroundings

### H. Check-in Based Guardian System (No Live Feed)

If live stream not available:
   Periodic auto check-ins prompt driver/passenger to confirm safety.
   Missed check-ins or silence→triggers alert to guardian or dispatch center.

### I. Snapshot Capture Feature

Users can tap a button to capture quick photo snapshots (internal or external).
Used when something feels off but doesn't warrant panic.
Auto-uploaded and time-stamped to cloud.

1. A rideshare safety system using a mobile device's internal and external camera to transmit real-time live video to a cloud server.

2. The system of claim 1, further comprising a unique safety code generator that enables remote access to the live video stream by a third party.

3. The system of claim 1, wherein the mobile device includes a microphone for recording audio, said audio analyzed using AI to detect distress patterns.

4. The system of claim 1, further comprising a facial recognition module to verify the identity of the driver at random or scheduled intervals.

5. The system of claim 1, wherein GPS and mapping data are used to identify deviations from an expected route and trigger alerts.

6. The system of claim 1, wherein onboard sensors detect sudden changes in velocity or orientation to identify possible threats or accidents.

7. The system of claim 1, wherein a panic detection system is operable through manual input, voice commands, or motion gestures. Also, person of trust may press panic button while watching also use gesture and voice commands. Last the stream security may also use panic button. Last resort when legal to do so. Also Ai, if legal to do so.

8. The system of claim 1, further comprising a dynamic safety scoring engine updated in real-time using environmental, biometric, audio, and motion data.

9. The system of claim 1, wherein live video is replaced with audio-only mode or check-in-based verification when video streaming is unavailable or restricted.

10. The system of claim 1, wherein person of trust are notified via the monitoring portal upon detection of anomalies.
